(19) United States
(12) Patent Application Publication
(10) Pub. No.: US 2004/0156953 A1
(43) Pub. Date: Aug. 12, 2004

(54) Encapsulated food additives and method for preparing foodstuffs

(76) Inventor: Ray A. Guidry, Breaux Bridge, LA (US)

Correspondence Address: Ted M. Anthony, Perret Doise, APLC, Suite 1200, 600 Jefferson Street, Lafayette, LA, 70501, US

(21) Appl. No.: 10/365,071

(22) Filed: Feb. 12, 2003

(51) Int. Cl. A23L 1/00

(52) U.S. Cl. 426/89

(57) ABSTRACT

Food additives are contained within degradable capsules, and a method for preparing foodstuffs by inserting degradable capsules containing food additives into such foodstuffs prior to cooking.

### FIELD OF THE INVENTION

The subject invention relates generally to encapsulated food additives and a method for preparing certain foodstuffs, especially meat, using such encapsulated additives. More particularly, but without restriction, this invention further relates to a unique method for introduction of desired additives, which may comprise seasonings, spices, vegetables and the like, directly into bodies of foodstuffs, including meats, poultry, vegetables and fruits.

### BACKGROUND OF THE INVENTION

1. Field of the Invention

The invention relates to encapsulated food additives, and a method for introducing such additives internally into foodstuffs prior to cooking.

2. Description of the Prior Art

Different techniques are used to prepare foods prior to cooking. For example, some foods, particularly meats, greatly benefit from having seasonings, spices, vegetables, other meats, etc. inserted into the body of the meat. Meats such as large roasts and whole fowls frequently have a relatively large volume combined with a relatively small surface area for surface application of spices, seasonings and/or other food additives. Introducing food additives directly into the body of meat or other food therefore permits a much greater amount of such additives to be applied.

Although various devices have been used to stuff foods with spices, seasonings and the like, drawbacks accompany them. For example, a knife blade may be used to pierce meat, then push back the meat in order to form a large pocket. Loose seasonings, spices and/or other additives must then be pushed into said large pocket. Frequently, a flap of meat must be held closed with toothpicks or the like, posing problems when such fixtures fall out, etc. Often, spices, seasonings and other food additives are in powder form, which can frequently be-difficult to handle and dose, and can often sinter and/or clump during storage.

Food seasoning devices are known in the prior art. U.S. Pat. No. 2,887,035 to DeSeversky shows a food seasoning injection device in which a hopper holds solid seasoning and tapers to a cylindrical section through which projects a piercing tube for inserting a part of the solid seasoning into meat, and the like. A problem with devices such as that of DeSeversky is plugging of the piercing or containing tube with meat on downward motion of the piercing tube. Furthermore, excessive pressure is required to force the piercing tube into the meat.

Injecting devices for a different purpose are shown in U.S. patents to Davis (U.S. Pat. No. 2,761,305), Sundholm (U.S. Pat. No. 3,286,887), and Moline (U.S. Pat. No. 3,717,222). Davis shows a device for injecting and compacting material into openings in concrete, brick, stone or other masonry, drawing material from a reservoir by means of a tamping rod into a fissure or opening. No means for creating the fissure or opening, however, are apparent from the device of Davis. Sundholm and Moline both show dispensing apparatus for applying grease, or the like, using a plunger assembly and nozzle. None of these patents, however, provides means for penetrating into the interior of meat and none could be expected to properly dispense seasoning materials within the interior of a meat product.

The present invention eliminates the need for chopping and/or preparing vegetables such as onions, garlic, peppers, and the like prior to adding said vegetables to food items to be cooked. Further, unlike known methods of “injecting” additives into food, the present invention requires no injecting or coring apparatus. Of course, the present invention eliminates the clean up requirements associated with such known methods.

### SUMMARY OF THE INVENTION

In the present invention, food additives are contained within degradable capsules. Although any number of different food additives can be contained within said capsules, in the preferred embodiment of the present invention, said food additives generally comprise seasonings, spices, vegetables, or some combination thereof. Such degradable capsules permit easy handling of desired food additives with minimal mess or preparation time. Further, such capsules dissolve or otherwise disintegrate when exposed to moisture and/or elevated temperatures.

Such capsules are typically inserted within the bodies of the foodstuffs to be cooked. The capsules can be placed directly inside fissures or other openings in the outer surface of said foodstuffs. However, it is frequently desirable to pierce the surface of the foodstuffs in order to make a small incision into the body thereof. In such cases, said capsules can be inserted directly into the resultant openings in the food body.

As the food is cooked, the capsules melt away due to the heat and moisture associated with the cooking process, allowing the food additives to come directly in contact with the food body. In most cases, such additives are absorbed into the food tissue or body. This allows for more even distribution of such additives throughout the body of the food.

Problems encountered in properly seasoning meat for cooking are overcome in the present invention by insuring that seasoning is inserted within the interior of the meat efficiently without loss of seasoning material. It is accordingly an object of the present invention to provide means for introducing food additives directly into the interior of foodstuffs, particularly meat products.

These together with other objects and advantages which will become subsequently apparent reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 is a side view of a capsule of the present invention.

FIG. 2 is a side view of a capsule of the present invention being inserted into a whole turkey.

FIG. 3 is a side view of a capsule of the present invention being inserted into a beef steak.

### DETAILED DESCRIPTION

The present invention provides for injecting seasoning, such as salt, pepper, tenderizer, garlic powder, and other condiments or seasoning materials into the interior of meat roasts, steaks, or the like. When seasoning is sprinkled on the surface of meat, a considerable amount of seasoning is generally carried away from the surface of the meat by juices which form during cooking. However, when such seasonings are placed within the meat, the seasoning can spread throughout the meat by juices formed during cooking, and the juices are retained inside the meat to promote a juicy, evenly flavored roast, or other form of cooked meat.

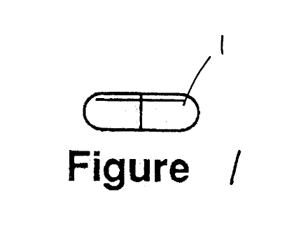

Referring to the drawings, FIG. 1 depicts a side view of a capsule 1 of the present invention. In the preferred embodiment, said capsule comprises a gelatin-based pharmaceutical capsule or the like which is well known in the art. However, any number of other degradable capsules or containment devices could be used. Regardless of the particular capsule used for this purpose, said capsule must be susceptible of melting at elevated temperatures anticipated during the conventional cooking process. Ideally, said capsules will also break down and/or disintegrate in response to prolonged exposure to moisture, such as juices or marinades present in the cooking process.

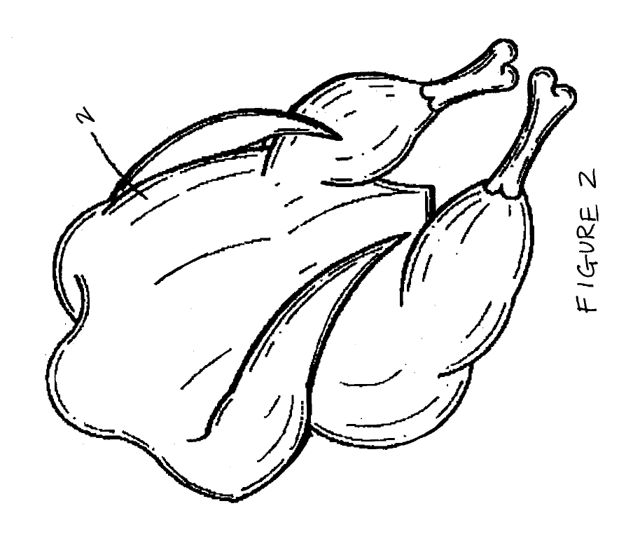

FIG. 2 depicts a side view of a capsule 1 of the present invention being inserted into a whole fowl 2 prior to cooking. Such capsules can be inserted directly into tissues or openings in the body of foodstuffs such as fowl 2 depicted in FIG. 2. Alternatively, the surface of fowl 2 can be pierced with a knife or other implement, in this case fork 3, and one or more capsules 1 of the present invention can be inserted directly into the resultant opening(s) in fowl 2.

Because of the relatively small size of capsules 1 of the present invention, said capsules can frequently be placed deep within the body of the food item such as fowl 2 using a single incision. Generally, there is no need to dig out or form a “pocket” within the body of the food. Similarly, there is also generally no need to form a “flap” or other containing means for securing such capsules within said food body.

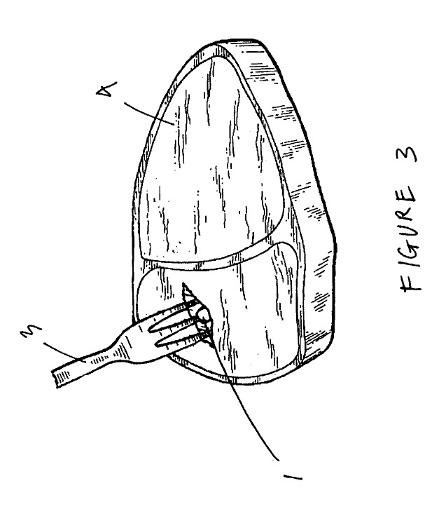

FIG. 3 depicts capsule 1 of the present invention being inserted within beef steak 4. As with the fowl depicted in FIG. 2, an incision can be made in said beef steak using a knife or other implement, such as fork 3.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed:

1. A degradable capsule containing at least one food additive.

2. The degradable food capsule recited in claim 1, wherein said food additive comprises at least one seasoning.

3. The degradable food capsule recited in claim 1, wherein said food additive comprises at least one spice.

4. A method of preparing foodstuff comprising the following steps:
a. inserting a degradable capsule containing at least one food additive into the body of said food stuff; and
b. cooking said food stuff.

5. A method of preparing foodstuff comprising the following steps:
a. making an incision in a foodstuff;
b. inserting a degradable capsule containing at least one food additive into the body of said food stuff; and
c. cooking said food stuff.
